(19) United States
(12) Patent Application Publication
(10) Pub. No.: US 2012/0177943 A1
(43) Pub. Date: Jul. 12, 2012

(54) METAL SUBSTRATE FOR SOLAR BATTERY AND METHOD OF MANUFACTURING METAL SUBSTRATE FOR SOLAR BATTERY

(75) Inventors: Shinji Yamamoto, Kyoto (JP); Ryouji Inoue, Hyogo (JP); Keita Watanabe, Osaka (JP); Masaaki Ishio, Osaka (JP)

(73) Assignee: NEOMAX MATERIALS CO., LTD., Suita-shi, Osaka (JP)

(21) Appl. No.: 13/123,602

(22) PCT Filed: Jan. 12, 2011
(86) PCT No.: PCT/JP2011/050324

§ 371 Date: Apr. 11, 2011

(51) Int. Cl. B32B 15/20; H01M 2/00; C23F 1/00; B32B 15/00; B32B 37/14

(52) U.S. Cl. 428/621; 428/615; 428/653; 428/676; 428/677; 428/655; 156/281; 216/33

(57) ABSTRACT

A metal substrate for a solar battery capable of inhibiting power generation efficiency of a unit solar cell from decrease due to a defect of the unit solar cell is provided. This metal substrate (1) for a solar battery includes a cladding material having a first metal layer (11) with a first surface (11a) formed with a unit solar cell (2) and a second metal layer (12) bonded to the first metal layer on a second surface (11b) opposite to the first surface, while a kurtosis (Rku) serving as an index indicating surface roughness of the first surface is not more than 7.

### TECHNICAL FIELD

The present invention relates to a metal substrate for a solar battery and a method of manufacturing a metal substrate for a solar battery, and more particularly, it relates to a metal substrate for a solar battery having a surface formed with a unit solar cell and a method of manufacturing a metal substrate for a solar battery.

### BACKGROUND ART

A metal substrate for a solar battery having a surface formed with a unit solar cell is known in general. Such a metal substrate for a solar battery having a surface formed with a unit solar cell is disclosed in Japanese Patent Publication No. 4-78030 and Japanese Patent Laying-Open No. 2009-117783, for example.

In the aforementioned Japanese Patent Publication No. 4-78030, a metal substrate material for a solar battery in which any one (first metal layer) of an Ni plate, an Al plate and a stainless steel plate is pressure-welded onto a surface of a stainless steel plate or a cold-rolled steel plate (second metal layer) is disclosed. In this metal substrate material for a solar battery described in Japanese Patent Publication No. 4-78030, a solar battery including an amorphous silicon thin film (unit solar cell) on a surface of the first metal layer is formed. Further, the metal substrate material for a solar battery described in Japanese Patent Publication No. 4-78030 is so treated that the size of a non-metal inclusion existing in the first metal layer is not more than 1.0 μm in order to inhibit the amorphous silicon thin film from being non-uniformly formed due to the non-metal inclusion existing in the first metal layer.

In the aforementioned Japanese Patent Laying-Open No. 2009-117783, a solar battery comprising a metal substrate in which an Al metal layer (first metal layer) is bonded onto a surface of an Ni metal layer (second metal layer) by a prescribed pressure (a surface of an Ni metal layer (second metal layer) is cladded with an Al metal layer (first metal layer)) and a silicon thin film (unit solar cell) formed on a surface of the Al metal layer is disclosed. In this solar battery described in Japanese Patent Laying-Open No. 2009-117783, the metal substrate is dipped in a mixture of phosphoric acid, glacial acetic acid and nitric acid to etch a surface of the metal substrate, and thereafter the silicon thin film is formed on the surface of the metal substrate. In Japanese Patent Laying-Open No. 2009-117783, a state of the surface of the metal substrate shortly before forming the silicon thin film (after etching) is not described.

### PRIOR ART DOCUMENT

### Patent Document

Patent Document 1: Japanese Patent Publication No. 4-78030

Patent Document 2: Japanese Patent Laying-Open No. 2009-117783

### SUMMARY OF THE INVENTION

### Problems to be Solved by the Invention

However, in the metal substrate material for a solar battery disclosed in the aforementioned Japanese Patent Publication No. 4-78030, portions where the amorphous silicon thin film is not sufficiently formed (defects such as a pinhole, a crack and a portion not formed with the film) are conceivably easily generated in a case where a non-metal inclusion sharply pointed, a groove portion recessed in a wedge shape and the like exist on the surface of the first metal layer, even when the size of a metal inclusion existing in the first metal layer is not more than 1.0 μm. Therefore, there is such a problem that power generation efficiency of the solar battery easily decreases due to the defects in the amorphous silicon thin film (unit solar cell).

In the solar battery disclosed in the aforementioned Japanese Patent Laying-Open No. 2009-117783, the state of the surface of the metal substrate after etching is not described, and hence portions where the silicon thin film is not sufficiently formed (defects such as a pinhole, a crack and a portion not formed with the film) are conceivably easily generated when an extraneous substance sharply pointed, a groove portion recessed in a wedge shape and the like exist on the surface of the metal substrate. Therefore, there is such a problem that power generation efficiency of the solar battery easily decreases due to the defects in the silicon thin film (unit solar cell).

The present invention has been proposed in order to solve the aforementioned problems, and an object of the present invention is to provide a metal substrate for a solar battery capable of inhibiting decrease of power generation efficiency of a unit solar cell due to a defect in the unit solar cell and a method of manufacturing a metal substrate for a solar battery.

### Means for Solving the Problems and Effect of the Invention

In order to attain the aforementioned object, the inventor has found as a result of a deep study that portions where a unit solar cell is not sufficiently formed (defects such as a pinhole, a crack and a portion not formed with a film) can be inhibited from being generated by controlling a kurtosis (sharpness) serving as an index indicating surface roughness of a first surface formed with the unit solar cell to not more than 7. In other words, a metal substrate for a solar battery according to a first aspect of the present invention comprises a cladding material including a first metal layer having a first surface formed with a unit solar cell and a second metal layer bonded to the first metal layer on a second surface opposite to the first surface, wherein a kurtosis (Rku) serving as an index indicating surface roughness of the first surface is not more than 7.

In the metal substrate for a solar battery according to the first aspect of the present invention, as hereinabove described, the kurtosis (Rku) of the first surface formed with the unit solar cell is not more than 7, whereby the first surface of the first metal layer is smoothly formed in a state where the kurtosis is not more than 7 even when an extraneous substance is formed (remains) on the first surface of the first metal layer, or a groove portion or the like is formed so that the first surface has a corrugated shape, and hence the unit solar cell can be substantially uniformly formed on the first surface. Thus, the defects such as a pinhole, a crack and a portion not formed with a film can be inhibited from being caused in the unit solar cell, and hence power generation efficiency of the unit solar cell can be inhibited from decrease due to the defects in the unit solar cell. In the present invention, the kurtosis of the first surface indicates a wide concept denoting a kurtosis of the first surface of the first metal layer including not only the first surface formed by the first metal layer but also a surface of an extraneous substance in a case where the extraneous substance other than the first metal layer adheres onto the first surface.

In the aforementioned metal substrate for a solar battery according to the first aspect, the kurtosis (Rku) of the first surface of the first metal layer is preferably smaller than that of a surface of the second metal layer, and the second metal layer preferably has higher rigidity than the first metal layer. According to this structure, the kurtosis of the first surface of the first metal layer is smaller than that of the surface of the second metal layer, whereby the unit solar cell can be more substantially uniformly formed on the surface (first surface) of the metal substrate for a solar battery, as compared with a case where the metal substrate for a solar battery is constituted by only the second metal layer. Further, the second metal layer has higher rigidity than the first metal layer, whereby rigidity of the metal substrate for a solar battery can be improved, as compared with a case where the metal substrate for a solar battery is constituted by only the first metal layer. Thus, deflection or the like can be inhibited from being caused on the metal substrate for a solar battery due to its own weight or the like in manufacturing the solar battery.

In the aforementioned metal substrate for a solar battery according to the first aspect, a difference between a thermal expansion coefficient of the second metal layer and a thermal expansion coefficient of the unit solar cell is preferably smaller than a difference between a thermal expansion coefficient of the first metal layer and the thermal expansion coefficient of the unit solar cell. According to this structure, the second metal layer having a thermal expansion coefficient close to the thermal expansion coefficient of the unit solar cell can inhibit the entire metal substrate for a solar battery from deformation due to deformation of the first metal layer with respect to the unit solar cell when the metal substrate for a solar battery is thermally deformed. Therefore, according to this structure, the power generation efficiency of the unit solar cell can be inhibited from decrease due to the defects in the unit solar cell while inhibiting the metal substrate for a solar battery from thermal deformation. “The thermal expansion coefficient of the unit solar cell” denotes a thermal expansion coefficient of a unit solar cell including no metal substrate.

In this case, the difference between the thermal expansion coefficient of the second metal layer and the thermal expansion coefficient of the unit solar cell is preferably not more than 5×10⁻⁶/°C. According to this structure, the thermal expansion coefficient of the second metal layer can be further approximated to the thermal expansion coefficient of the unit solar cell, and hence the metal substrate for a solar battery can be reliably inhibited from thermal deformation.

In the aforementioned metal substrate for a solar battery according to the first aspect, the first metal layer preferably has greater ductility than the second metal layer. According to this structure, the first metal layer has greater ductility and is easier to plastically deform than the second metal layer in rolling when forming the metal substrate for a solar battery, and hence the first surface of the first metal layer can be previously smoothed to some extent even when an inclusion exists on the first surface of the first metal layer. Thus, the Rku of the first surface of the first metal layer can be easily set to not more than 7. The term “ductility” denotes a property in which a substance is elongated without destruction even when force exceeding elastically deformable limits is applied to the substance. The term “greater ductility” indicates a property of being easily further elongated, and more specifically, it indicates a large elongation obtained by a tensile test. The term “inclusion” denotes an extraneous substance already existing in an ingot when casting metal into the ingot.

In the aforementioned metal substrate for a solar battery according to the first aspect, the first metal layer is preferably made of any one of Al, Cu, an Al alloy and a Cu alloy, and the second metal layer is preferably made of Fe or ferritic stainless steel. According to this structure, any one of Al, Cu, an Al alloy and a Cu alloy superior in ductility is employed in the first metal layer, whereby the first metal layer is easy to extend in rolling when forming the metal substrate for a solar battery, and hence the first surface of the first metal layer can be previously smoothed to some extent. Thus, the Rku of the first surface of the first metal layer can be easily set to not more than 7. Further, any one of Al, Cu, an Al alloy and a Cu alloy having a relatively small electrical resistance is employed in the first metal layer, whereby a loss in transmitting power generated in the unit solar cell can be reduced. Further, Fe or ferritic stainless steel having high rigidity is employed in the second metal layer, whereby the rigidity of the metal substrate for a solar battery can be easily increased.

In this case, a thickness of the second metal layer is preferably at least 60% of a total thickness including at least a thickness of the first metal layer and a thickness of the second metal layer. According to this structure, a ratio of Fe or ferritic stainless steel having high rigidity, constituting the second metal layer is at least 60%, and hence rigidity of the metal substrate for a solar battery can be reliably increased. In the aforementioned metal substrate for a solar battery in which the first metal layer is made of any one of Al, Cu, an Al alloy and a Cu alloy and the second metal layer is made of Fe or ferritic stainless steel, a thickness of the first metal layer is preferably at least 1.5 μm. According to this structure, an Fe component of the second metal layer can be inhibited from diffusing to the first metal layer to reach the first surface of the first metal layer when heat generated in growing a layer constituting the unit solar cell on a surface of the metal substrate for a solar battery is applied to the metal substrate for a solar battery. Inventors of this application have already also confirmed this point by an experiment.

In the aforementioned metal substrate for a solar battery in which the first metal layer is made of any one of Al, Cu, an Al alloy and a Cu alloy and the second metal layer is made of Fe or ferritic stainless steel, the first metal layer preferably has an Al content of at least 99.7 mass %. According to this structure, the first metal layer is easier to extend in rolling when forming the metal substrate for a solar battery, and hence the first surface of the first metal layer can be further smoothed. Thus, the Rku of the first surface can be more easily set to not more than 7. Further, the first metal layer has an impurity of less than 0.3%, and hence the impurity in the first metal layer can be inhibited from diffusion to the unit solar cell.

In the aforementioned metal substrate for a solar battery in which the first metal layer is made of any one of Al, Cu, an Al alloy and a Cu alloy and the second metal layer is made of Fe or ferritic stainless steel, the second metal layer is preferably made of ferritic stainless steel. According to this structure, the rigidity of the metal substrate for a solar battery can be increased while providing corrosion resistance to the external environment to the metal substrate for a solar battery.

In the aforementioned metal substrate for a solar battery according to the first aspect, a semiconductor layer of the unit solar cell, made of any one of Si, CuInSe₂, CuIn₁₋ₓGaₓSe₂, Cu₂ZnSnS₄ and CdTe is preferably grown on the first surface of the first metal layer. In this unit solar cell having the semiconductor layer made of any one of Si, CuInSe₂, CuIn₁₋ₓGaₓSe₂, Cu₂ZnSnS₄ and CdTe, the kurtosis of the first surface formed with the unit solar cell is set to not more than 7, whereby the unit solar cell can be substantially uniformly formed on the first surface of the first metal layer.

In the aforementioned metal substrate for a solar battery according to the first aspect, at least one of an extraneous substance, a valley portion and a mountain portion preferably exists on the first surface of the first metal layer, and the kurtosis (Rku) of the first surface on which at least one of the extraneous substance, the valley portion and the mountain portion exists is preferably not more than 7. The unit solar cell in which the defects such as a pinhole, a crack and a portion not formed with a film are inhibited from being caused can be formed on the first surface of the first metal layer by setting the kurtosis of the first surface formed with the unit solar cell to not more than 7, even when at least one of the extraneous substance, the valley portion and the mountain portion exists on the first surface of the first metal layer, as described above.

A method of manufacturing a metal substrate for a solar battery according to a second aspect of the present invention comprises steps of forming a metal substrate for a solar battery comprising a cladding material including a first metal layer having a first surface formed with a unit solar cell and a second metal layer bonded to the first metal layer on a second surface opposite to the first surface by bonding a first metal plate and a second metal plate to each other, and setting a kurtosis (Rku) serving as an index indicating surface roughness of the first surface to not more than 7 by polishing the first surface of the first metal layer.

As hereinabove described, the method of manufacturing a metal substrate for a solar battery according to the second aspect of the present invention comprises the step of setting the kurtosis (Rku) serving as an index indicating surface roughness of the first surface to not more than 7 by polishing the first surface of the first metal layer is comprised, whereby the first surface of the first metal layer is smoothly formed in a state where the kurtosis is not more than 7 even when an extraneous substance is formed (remains) on the first surface of the first metal layer, or a groove portion or the like is formed so that the first surface has a corrugated shape, and hence a unit solar cell can be substantially uniformly formed on the first surface. Thus, defects such as a pinhole, a crack and a portion not formed with a film can be inhibited from being caused in the unit solar cell, and hence power generation efficiency of the unit solar cell can be inhibited from decrease due to the defects in the unit solar cell.

In the aforementioned method of manufacturing a metal substrate for a solar battery according to the second aspect, the step of setting the kurtosis (Rku) of the first surface of the first metal layer to not more than 7 preferably includes a step of polishing the first surface of the first metal layer by chemical polishing. According to this structure, the kurtosis of the first surface of the first metal layer can be easily set to not more than 7.

In this case, the step of forming the metal substrate for a solar battery preferably includes a step of forming the metal substrate for a solar battery comprising the cladding material including the first metal layer made of any one of Al, Cu, an Al alloy and a Cu alloy and the second metal layer by bonding the first metal plate made of any one of Al, Cu, an Al alloy and a Cu alloy and the second metal plate to each other, and the step of polishing the first surface of the first metal layer by the chemical polishing preferably has a step of polishing the first surface of the first metal layer by dipping the metal substrate for a solar battery in a chemical polishing liquid containing phosphoric acid. According to this structure, the metal substrate for a solar battery is dipped in the chemical polishing liquid containing phosphoric acid, whereby the kurtosis of the first surface of the first metal layer made of any one of Al, Cu, an Al alloy and a Cu alloy can be easily set to not more than 7.

In the aforementioned method of manufacturing a metal substrate for a solar battery according to the second aspect, the step of forming the metal substrate for a solar battery preferably includes a step of forming the metal substrate for a solar battery comprising the cladding material including the first metal layer made of any one of Al, Cu, an Al alloy and a Cu alloy and the second metal layer made of Fe or ferritic stainless steel by bonding the first metal plate made of any one of Al, Cu, an Al alloy and a Cu alloy and the second metal plate made of Fe or ferritic stainless steel to each other. According to this structure, any one of Al, Cu, an Al alloy and a Cu alloy superior in ductility is employed in the first metal layer, whereby the first metal layer is easy to extend in rolling when forming the metal substrate for a solar battery, and hence the first surface of the first metal layer can be previously smoothed to some extent. Thus, the Rku of the first surface of the first metal layer can be easily set to not more than 7 in the step of polishing the first surface of the first metal layer. Further, any one of Al, Cu, an Al alloy and a Cu alloy having a relatively small electrical resistance is employed in the first metal layer, whereby a loss in transmitting power generated in the unit solar cell can be reduced. Further, Fe or ferritic stainless steel having high rigidity is employed in the second metal layer, whereby the rigidity of the metal substrate for a solar battery can be easily increased.

In this case, the step of forming the metal substrate for a solar battery preferably includes a step of forming the metal substrate for a solar battery so that a thickness of the second metal layer is at least 60% of a total thickness including at least a thickness of the first metal layer and a thickness of the second metal layer. According to this structure, a ratio of Fe or ferritic stainless steel having high rigidity, constituting the second metal layer is at least 60%, and hence rigidity of the metal substrate for a solar battery can be reliably increased.

In the aforementioned method of manufacturing a metal substrate for a solar battery comprising the step of forming the metal substrate for a solar battery including the cladding material having the first metal layer made of any one of Al, Cu, an Al alloy and a Cu alloy and the second metal layer made of Fe or ferritic stainless steel, the step of forming the metal substrate for a solar battery preferably includes a step of forming the metal substrate for a solar battery so that a thickness of the first metal layer is at least 1.5 μm. According to this structure, an Fe component of the second metal layer can be inhibited from diffusing to the first metal layer to reach the first surface of the first metal layer when heat generated in growing a layer constituting the unit solar cell on a surface of the metal substrate for a solar battery is applied to the metal substrate for a solar battery.

In the aforementioned method of manufacturing a metal substrate for a solar battery according to the second aspect, the step of forming the metal substrate for a solar battery preferably includes a step of cold-rolling the cladding material after forming the cladding material by bonding the first metal plate having greater ductility than the second metal plate and the second metal plate to each other. According to this structure, the cladding material is cold-rolled, whereby the first metal layer can be more extended than the second metal layer, and hence the first surface of the first metal layer can be previously smoothed to some extent. Thus, the Rku of the first surface of the first metal layer can be easily set to not more than 7 in the step of polishing the first surface of the first metal layer.

In the aforementioned method of manufacturing a metal substrate for a solar battery in which the step of setting the kurtosis of the first surface to not more than 7 includes the step of polishing the first surface by chemical polishing, the step of forming the metal substrate for a solar battery preferably includes a step of continuously forming the cladding material by bonding the rolled first metal plate and the rolled second metal plate to each other, and the step of setting the kurtosis (Rku) of the first surface of the first metal layer to not more than 7 preferably includes a step of chemically polishing the first surface of the first metal layer of the continuously formed cladding material. According to this structure, the metal substrate for a solar battery in which the kurtosis (Rku) of the first surface of the first metal layer is not more than 7 can be continuously manufactured, and hence the productivity of the metal substrate for a solar battery can be improved.

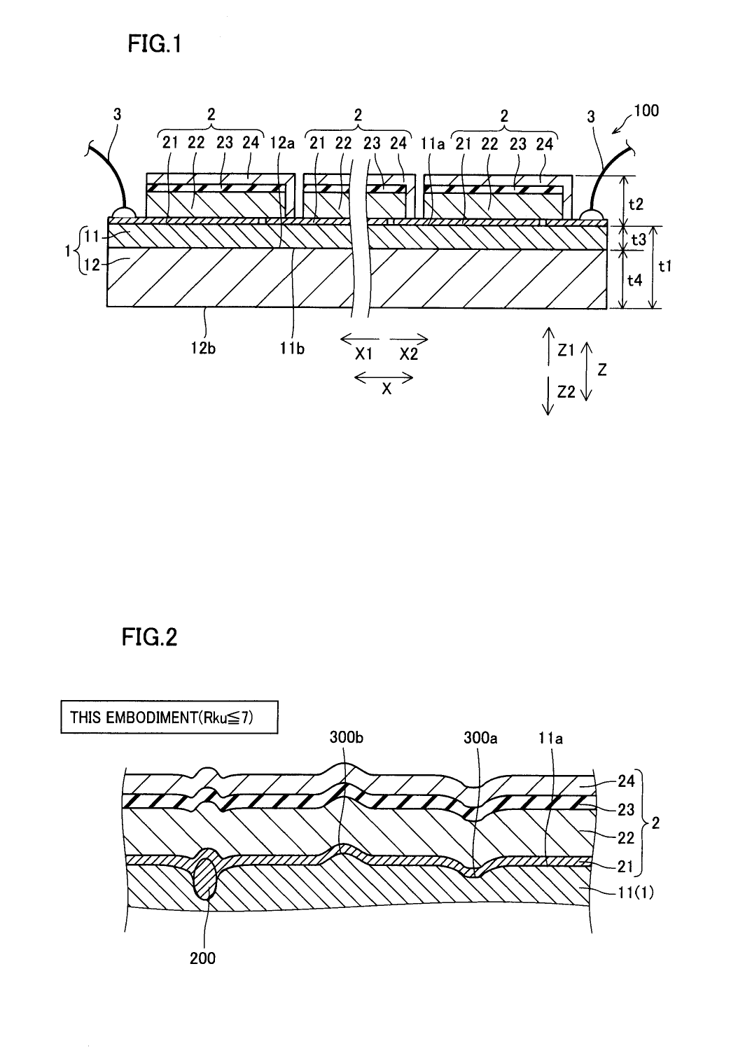

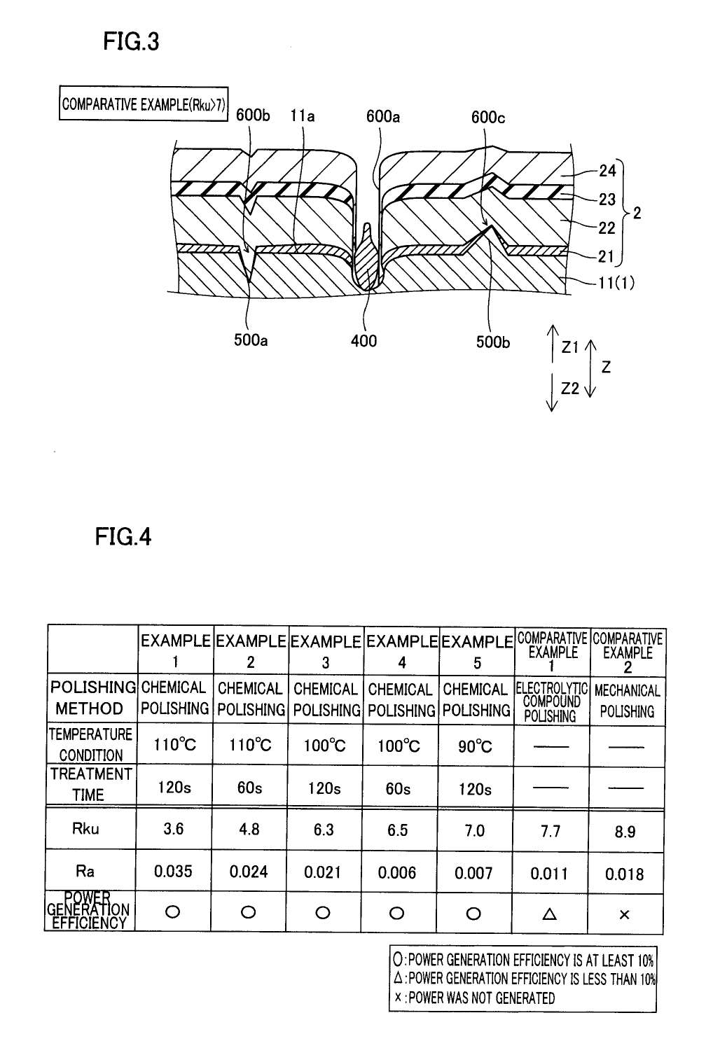

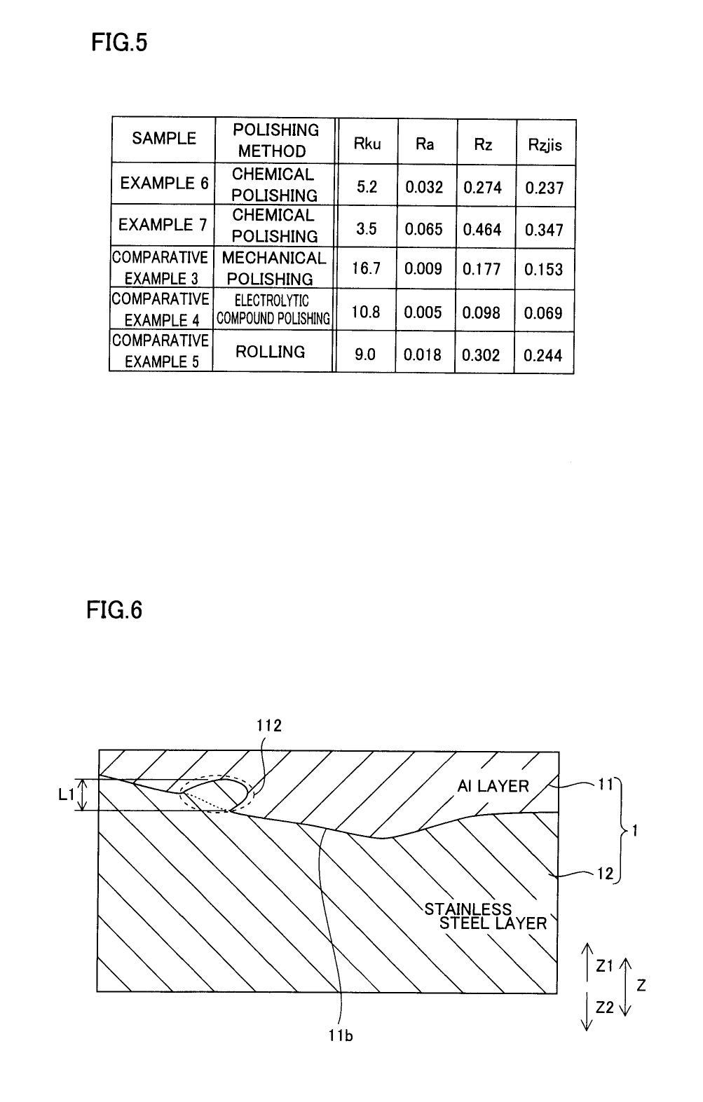

### BRIEF DESCRIPTION OF THE DRAWINGS

[FIG. 1] A sectional view showing the structure of a CIGS solar battery according to an embodiment of the present invention.

[FIG. 2] A sectional view showing the layered structure of a metal substrate and a unit solar cell in a case where an extraneous substance, a valley portion and a mountain portion exist on an upper surface of the metal substrate according to the embodiment of the present invention.

[FIG. 3] A sectional view showing the layered structure of a metal substrate and a unit solar cell in a case where an extraneous substance, a valley portion and a mountain portion exist on an upper surface of the metal substrate according to a comparative example of the present invention.

[FIG. 4] A diagram showing results of experiments on surface roughness of metal substrates and power generation efficiency of CIGS solar batteries performed for confirming the effects of the present invention.

[FIG. 5] A diagram showing results of experiments on surface roughness of metal substrates performed for confirming the effects of the present invention.

[FIG. 6] A diagram showing a result of an experiment on a Fe diffusion distance of the metal substrate performed for confirming the effects of the present invention.

### MODES FOR CARRYING OUT THE INVENTION

An embodiment of the present invention is now described with reference to the drawings.

First, the structure of a CIGS solar battery 100 according to the embodiment of the present invention is described with reference to FIGS. 1 to 3.

The CIGS solar battery 100 according to the embodiment of the present invention comprises a metal substrate 1 and a plurality of unit solar cells 2 each constituted by thin films formed on an upper surface 11a of the metal substrate 1 (Z1 side), as shown in FIG. 1. The metal substrate 1 has a thickness t1 of about 100 μm while the unit solar cells 2 each have a thickness t2 of about 3 μm. The metal substrate 1 is examples of the “cladding material” and the “metal substrate for a solar battery” in the present invention.

The plurality of unit solar cells 2 each are formed by successively stacking a lower electrode 21, a light absorption layer 22, a buffer layer 23 and an upper electrode 24 upward (in a direction Z1) from a lower side (Z2 side). The lower electrode 21 is formed at a prescribed interval from another lower electrode 21 in a transverse direction (direction X) on the upper surface 11a of the metal substrate 1. The light absorption layer 22 is formed on not only a surface of a lower electrode 21 of a corresponding unit solar cell 2 but also part of a surface of a lower electrode 21 of a unit solar cell 2 adjacent to the corresponding unit solar cell 2. The buffer layer 23 is formed on a surface of the light absorption layer 22. The upper electrode 24 is formed to cover an upper surface of the buffer layer 23, side surfaces of the light absorption layer 22 and the buffer layer 23 and the surface of the lower electrode 21 of the adjacent unit solar cell 2.

The lower electrode 21 is constituted by an Mo metal film having a thickness of about 500 nm. The light absorption layer 22 is made of a semiconductor having a composition of Cu(In₁₋ₓGaₓ)Se₂ (CIGS). Electrons are emitted when this light absorption layer 22 absorbs light, whereby power is generated in the unit solar cell 2. The buffer layer 23 is made of CdS while the upper electrode 24 is made of light-transmittable ZnO. A thermal expansion coefficient of the whole unit solar cells 2 is about 10×10⁻⁶/°C. The thermal expansion coefficient of the whole unit solar cells 2 denotes a thermal expansion coefficient of the whole unit solar cells 2 including no metal substrate 1. The light absorption layer 22 is an example of the “semiconductor layer” in the present invention.

In the plurality of unit solar cells 2, an upper electrode 24 of a unit solar cell 2 on one side (X1 side) of unit solar cells 2 adjacent to each other and a lower electrode 21 of a unit solar cell 2 on the other side (X2 side) of the unit solar cells 2 adjacent to each other are electrically connected with each other. Thus, the plurality of unit solar cells 2 are serially connected with each other along the direction X on the upper surface 11a of the metal substrate 1.

A lower electrode 21 of a unit solar cell 2 located on an end on the X1 side and a lower electrode 21 of a unit solar cell 2 located on an end on the X2 side each are connected with a terminal 3 for extracting power generated in the plurality of unit solar cells 2.

The metal substrate 1 is made of a cladding material in which an Al layer 11 and a stainless steel layer 12 are bonded to each other vertically (in a direction Z). More specifically, a lower surface 11b of the Al layer 11 and an upper surface 12a of the stainless steel layer 12 are bonded onto each other by a prescribed pressure, thereby forming the cladding material constituted by the Al layer 11 and the stainless steel layer 12. The Al layer 11 is an example of the “first metal layer” in the present invention, and the stainless steel layer 12 is an example of the “second metal layer” in the present invention. The upper surface 11a is an example of the “first surface” in the present invention, and the lower surface 11b is an example of the “second surface” in the present invention. The Al layer 11 has an Al content of at least about 99.7%, and the remaining less than 0.3% is impurities mainly containing Fe. A thermal expansion coefficient of the Al layer 11 is about 23×10⁻⁶PC and large as compared with the thermal expansion coefficient (about 10×10⁻⁶/°C.) of the unit solar cells 2. A thickness t3 of the Al layer 11 is about 15 μm. In other words, the thickness t3 of the Al layer 11 is about 15% of the thickness t1 (=about 100 μm) of the metal substrate 1.

The stainless steel layer 12 is made of SUS430 (JIS standard) having corrosion resistance to the external environment (such as moisture). More specifically, the stainless steel layer 12 is made of an Fe alloy (ferritic stainless steel) containing at least about 16% and not more than about 18% of Cr. A thermal expansion coefficient of the stainless steel layer 12 is about 11×10⁻⁶PC in a temperature range of 20° C. to 550° C. In other words, there is a difference of about 13×10⁻⁶PC between the thermal expansion coefficient (about 23×10⁻⁶/°C.) of the Al layer 11 and the thermal expansion coefficient (about 10×10⁻⁶/°C.) of the unit solar cells 2 whereas there is a difference of about 1×10⁻⁶/°C. between the thermal expansion coefficient (about 11×10⁻⁶/°C.) of the stainless steel layer 12 and the thermal expansion coefficient (about 10×10⁻⁶/°C.) of the unit solar cells 2. A thickness t4 of the stainless steel layer 12 is about 85 μm. In other words, the thickness t4 of the stainless steel layer 12 is about 85% of the thickness t1 (=about 100 μm) of the metal substrate 1.

The stainless steel layer 12 made of SUS430 is highly rigid and hardly deformed by external force as compared with the Al layer 11. On the other hand, the Al layer 11 has great ductility and is easy to extend as compared with the stainless steel layer 12.

According to the embodiment, the upper surface 11a of the Al layer 11 is so surface-treated that a kurtosis (Rku) thereof is not more than about 7.

A kurtosis (Rku) is now described. A kurtosis is a kind of index indicating surface roughness and denotes an index indicating sharpness of a corrugated shape formed on a surface. More specifically, a kurtosis is an index obtained by dividing the fourth power of a height Z in a reference length (Lr) by the fourth power of a root-mean-square height (Rq) denoting standard deviation of surface roughness, as shown in the following formula (1). A small kurtosis means that a corrugated shape of a surface is smooth. On the other hand, a large kurtosis means that a corrugated shape of a surface is sharply pointed.

$$Rku = \frac{1}{{Rq}^{4}} ( \frac{1}{Lr} {\int }_{0}^{Lr} {Z ( x )}^{4} d x ) \qquad [ Formula 1 ]$$

Therefore, when the kurtosis is not more than about 7, a whole area including not only an upper surface 11a without an extraneous substance 200, a valley portion 300a and a mountain portion 300b but also a surface of the extraneous substance 200, an interface between the extraneous substance 200 and the upper surface 11a, an upper surface 11a of a portion formed with the valley portion 300a and an upper surface 11a of a portion formed with the mountain portion 300b is smooth, even in a case where the extraneous substance 200, the valley portion (groove portion) 300a and the mountain portion 300b exist in the metal substrate 1 (the upper surface 11a of the Al layer 11), as shown in FIG. 2. Thus, the unit solar cells 2 are formed to have a substantially uniform layered structure over the whole area including not only the upper surface 11a without the extraneous substance 200, the valley portion 300a and the mountain portion 300b but also the surface of the extraneous substance 200, the interface between the extraneous substance 200 and the upper surface 11a, the upper surface 11a of the portion formed with the valley portion 300a and the upper surface 11a of the portion formed with the mountain portion 300b. The extraneous substance 200 includes an extraneous substance (narrowly-defined extraneous substance) adhering to a surface from outside after casting metal into an ingot and an extraneous substance (inclusion) already existing in an ingot when casting metal into the ingot.

On the other hand, when the kurtosis is more than about 7, an extraneous substance 400 sharply pointed adheres onto the metal substrate 1 (the upper surface 11a of the Al layer 11), and a valley portion (groove portion) 500a and a mountain portion 500b both sharply pointed are formed, whereby a hole-shaped (groove-shaped) defect 600a is formed at a position of the extraneous substance 400 while defects 600b and 600c in which the layered structure of the unit solar cell 2 is incomplete are formed at positions of the valley portion 500a and the mountain portion 500b in the unit solar cell 2, as shown in FIG. 3. In this case, the upper electrode 24 is formed along an inner surface of the defect 600a, whereby the upper electrode 24 is formed to come into contact with the upper surface 11a of the metal substrate 1. Thus, the upper electrode 24 and the metal substrate 1 short-circuit, whereby power is not generated in the unit solar cell 2. Further, the layered structure of the unit solar cell 2 is incomplete at the positions of the defects 600b and 600c, and hence power is not sufficiently generated in the unit solar cell 2 at the positions of the defects 600b and 600c.

Kurtoses of the upper surface 12a and a back surface 12b of the stainless steel layer 12 are larger than the kurtosis of the upper surface 11a of the Al layer 11. The kurtosis of the upper surface 11a of the Al layer 11 is a kurtosis in a direction (not shown) perpendicular to a rolling direction (a direction in which a material to be rolled is transported in roll working) in bonding the Al layer 11 and the stainless steel layer 12 to each other, of an in-plane direction of the upper surface 11a. Thus, when measuring the kurtosis in the direction perpendicular to the rolling direction, an extraneous substance and a valley portion (groove portion) of the upper surface 11a are likely to be measured, and hence an index indicating a state (sharpness) of the upper surface 11a of the Al layer 11 can be more reliably obtained, as compared with a case where the kurtosis is measured in the rolling direction.

Next, a manufacturing process for the CIGS solar battery 100 according to the embodiment of the present invention is described with reference to FIGS. 1 and 2.

First, a rolled Al plate (not shown) containing at least about 99.7% of Al and a rolled stainless steel plate (not shown) made of SUS430 are prepared. A thickness of the Al plate is about 15% of the total thickness of the Al plate and the stainless steel plate while a thickness of the stainless steel plate is about 85% of the total thickness of the Al plate and the stainless steel plate.

Then, the rolled Al plate and the rolled stainless steel plate are unrolled to be continuously bonded to each other by a rolling mill (not shown). At this time, the Al plate and the stainless steel plate are pressure-welded by applying a prescribed pressure while transporting the Al plate and the stainless steel plate in a rolling direction (not shown). Thereafter, the pressure-welded Al plate and stainless steel plate are cold-rolled. Thus, the Al layer 11 having the thickness t3 of about 15 μm and the stainless steel layer 12 having the thickness t4 of about 85 μm are bonded to each other (the stainless steel layer 12 having the thickness t4 of about 85 μm is cladded with the Al layer 11 having the thickness t3 of about 15 μm) to continuously form the cladding material having the thickness t1 of about 100 μm. At this time, in the stainless steel plate, stainless steel is inferior in ductility and unlikely to be plastically deformed, and hence stainless steel around an inclusion (not shown) may be broken in rolling and a dent may be formed around the inclusion when the inclusion exists on a surface thereof. On the other hand, in the Al plate, Al is superior in ductility and likely to be plastically deformed, and hence Al around an inclusion (not shown) is plastically deformed in rolling, whereby a dent is unlikely to be formed around the inclusion even when the inclusion exists on an upper surface of the Al plate. Consequently, the upper surface 11a of the Al layer 11 is formed flatly to some extent.

According to the embodiment, the upper surface 11a of the Al layer 11 of the cladding material continuously formed is chemically polished. More specifically, the cladding material is dipped in a chemical polishing liquid made of a phosphoric acid solution containing about 4% of nitric acid, maintained at a temperature range of at least about 90° C. and not more than about 120° C. for at least about 10 seconds and not more than about 120 seconds, thereby performing chemical polishing. Thus, the cladding material having a kurtosis of not more than about 7 on the upper surface 11a of the Al layer 11 is continuously formed. Thereafter, the chemically polished cladding material is cut into a prescribed size, whereby the metal substrate 1 having a kurtosis of not more than about 7 on the upper surface 11a of the Al layer 11 is formed. Before the upper surface 11a of the Al layer 11 of the cladding material is chemically polished, polishing such as mechanical polishing is not performed on the upper surface 11a.

Then, the lower electrode 21 having a thickness of about 500 nm and made of an Mo metal film is formed on the upper surface 11a of the Al layer 11 by sputtering or the like. At this time, a thickness of the Mo metal film constituting the lower electrode 21 is very small, and hence smoothness of the upper surface 11a of the underlying Al layer 11 on which the kurtosis is not more than about 7 is reflected in the lower electrode 21. Thus, an upper surface of the lower electrode 21 is smoothly formed, and hence the light absorption layer 22, the buffer layer 23 and the upper electrode 24 formed on the upper surface of the lower electrode 21 can be uniformly formed.

Thereafter, the light absorption layer 22 made of a semiconductor having a composition of Cu(In₁₋ₓGaₓ)Se₂ (CIGS) is formed in a prescribed region on the surface of the lower electrode 21 by multi-source vapor deposition or the like under a temperature condition of at least about 350° C. and not more than about 500° C. In an Fe diffusion distance measurement described later, part of Fe in the stainless steel layer 12 diffused from a side of the lower surface 11b of the Al layer 11 to the inside of the Al layer 11 when keeping the metal substrate 1 under a temperature condition of 400° C. for 10 hours. Consequently, due to the aforementioned temperature condition of at least about 350° C. and not more than about 500° C., the part of Fe in the stainless steel layer 12 of the metal substrate 1 conceivably diffuses from the side of the lower surface 11b of the Al layer 11 to the inside of the Al layer 11 in the direction Z1 by a distance of about 1.5 μm.

Then, the buffer layer 23 made of CdS is formed on the surface of the light absorption layer 22 by chemical deposition or the like. Finally, the upper electrode 24 made of ZnO is formed to cover the upper surface of the buffer layer 23, the side surfaces of the light absorption layer 22 and the buffer layer 23 and the surface of the lower electrode 21 of the adjacent unit solar cell 2. Thus, the plurality of unit solar cells 2 each having the thickness t2 of about 3 μm and serially connected with each other through the upper electrode 24 are formed on the upper surface 11a of the metal substrate 1.

The lower electrode 21 of the unit solar cell 2 located on the end on the X1 side and the lower electrode 21 of the unit solar cell 2 located on the end on the X2 side each are connected with the terminal 3, whereby the CIGS solar battery 100 shown in FIG. 1 is manufactured.

According to the embodiment, as hereinabove described, the upper surface 11a of the Al layer 11 where the extraneous substance 200, the valley portion (groove portion) 300a and the mountain portion 300b exist is chemically polished with the chemical polishing liquid containing phosphoric acid so that the kurtosis is not more than about 7, whereby the upper surface 11a of the Al layer 11 is smoothly formed in a state where the kurtosis is not more than about 7 by chemically polishing the upper surface 11a of the Al layer 11 with the chemical polishing liquid containing phosphoric acid even when the extraneous substance 200 is formed (remains) on the upper surface 11a of the Al layer 11, or a groove portion 300 or the like is formed so that irregularities are formed on the upper surface 11a, and hence the unit solar cells 2 can be substantially uniformly formed on the upper surface 11a. Thus, defects such as a pinhole, a crack and a portion not formed with a film (defects 600a, 600b and 600c) can be inhibited from being caused in the unit solar cells 2, and hence power generation efficiency of the unit solar cells 2 can be inhibited from decrease due to the defects in the unit solar cells 2. Consequently, the yield of the CIGS solar battery 100 can be improved. Further, the metal substrate 1 is dipped in the chemical polishing liquid containing phosphoric acid, whereby the kurtosis of the upper surface 11a of the Al layer 11 can be easily set to not more than about 7.

According to the embodiment, as hereinabove described, if the kurtosis of the upper surface 11a of the Al layer 11 is rendered smaller than the kurtoses of the upper surface 12a and the back surface 12b of the stainless steel layer 12, the unit solar cells 2 can be more substantially uniformly formed on the surface (upper surface 11a) of the metal substrate 1, as compared with a case where the metal substrate 1 is constituted by only the stainless steel layer 12.

According to the embodiment, as hereinabove described, if rigidity of the stainless steel layer 12 made of SUS430 is rendered high as compared with the Al layer 11 having an Al content of at least about 99.7%, rigidity of the metal substrate 1 can be improved, as compared with a case where the metal substrate 1 is constituted by only the Al layer 11. Thus, deflection or the like can be inhibited from being caused on the metal substrate 1 due to its own weight or the like in manufacturing the CIGS solar battery 100.

According to the embodiment, as hereinabove described, if the difference between the thermal expansion coefficient (about 11×10⁻⁶/°C.) of the stainless steel layer 12 and the thermal expansion coefficient (about 10×10⁻⁶/°C.) of the unit solar cells 2 is not more than 5×10⁻⁶/°C. and rendered smaller than the difference between the thermal expansion coefficient (about 23×10⁻⁶/°C.) of the Al layer 11 and the expansion coefficient (about 10×10⁻⁶/°C.) of the unit solar cells 2, the stainless steel layer 12 having a thermal expansion coefficient close to the thermal expansion coefficient of the unit solar cells 2 can inhibit the entire metal substrate 1 from deformation due to deformation of the Al layer 11 with respect to the unit solar cells 2 when the metal substrate 1 is thermally deformed. Therefore, the power generation efficiency of the unit solar cells 2 can be inhibited from decrease due to the defects in the unit solar cells 2 while reliably inhibiting the metal substrate 1 from thermal deformation.

According to the embodiment, as hereinabove described, if the Al layer 11 is formed to have great ductility and be easy to extend as compared with the stainless steel layer 12, and have an Al content of at least about 99.7%, the Al layer 11 has greater ductility and is easier to deform plastically than the stainless steel layer 12, and hence the upper surface 11a of the Al layer 11 can be previously smoothed to some extent by cold-rolling the cladding material, even when an inclusion exists on the upper surface 11a of the Al layer 11. Thus, the kurtosis of the upper surface 11a of the Al layer 11 can be easily set to not more than about 7 when chemically polishing the upper surface 11a of the Al layer 11. Further, if Al having a relatively small electrical resistance is employed in the Al layer 11, a loss in transmitting power generated in the unit solar cells 2 can be reduced. The Al layer 11 has impurities (mainly Fe) of less than 0.3% and a low Fe content, and hence the impurities in the Al layer 11 can be inhibited from diffusion to the unit solar cells 2.

According to the embodiment, as hereinabove described, if the stainless steel layer 12 is made of SUS430, the rigidity of the metal substrate 1 can be easily improved. If SUS430 having corrosion resistance is employed in the stainless steel layer 12, corrosion resistance to the external environment can be provided to the metal substrate 1.

According to the embodiment, as hereinabove described, if the thickness t4 of the stainless steel layer 12 is about 85 μm, which is about 85% of the thickness t1 (=about 100 μm) of the metal substrate 1, the ratio of the SUS430 having high rigidity and constituting the stainless steel layer 12 is about 85%, and hence the rigidity of the metal substrate 1 can be reliably increased. Further, the stainless steel layer 12 having a thermal expansion coefficient close to the thermal expansion coefficient of the unit solar cells 2 can inhibit the entire metal substrate 1 from deformation due to deformation of the Al layer 11 with respect to the unit solar cells 2 when the metal substrate 1 is thermally deformed.

According to the embodiment, as hereinabove described, if the thickness t3 of the Al layer 11 is about 15 μm, an Fe component of the stainless steel layer 12 can be inhibited from diffusing to the Al layer 11 to reach the upper surface 11a of the Al layer 11 when heat generated in growing the light absorption layer 22 or the like constituting the unit solar cell 2 on the upper surface 11a of the metal substrate 1 is applied to the metal substrate 1. Thus, the Fe component of the stainless steel layer 12 can be inhibited from passing through the lower electrode 21 having a very small thickness to reach the light absorption layer 22 made of a semiconductor having a composition of Cu(In₁₋ₓGaₓ)Se₂ (CIGS). Consequently, defects can be inhibited from being caused on the light absorption layer 22 due to the Fe component, and hence the power generation efficiency or the like can be inhibited from decrease due to a decreased concentration of an acceptor in the light absorption layer 22.

According to the embodiment, as hereinabove described, the kurtosis of the upper surface 11a of the Al layer 11 formed with the unit solar cells 2 is set to not more than about 7, whereby the unit solar cells 2 can be substantially uniformly formed on the upper surface 11a of the Al layer 11, also when growing a semiconductor layer of the unit solar cell 2 made of CuIn₁₋ₓGaₓSe₂ on the upper surface 11a of the Al layer 11.

According to the embodiment, as hereinabove described, if the rolled Al plate and the rolled stainless steel plate are continuously bonded to each other by a rolling mill thereby continuously forming the cladding material while the upper surface 11a of the Al layer 11 of the continuously formed cladding material is chemically polished, the metal substrate 1 in which the kurtosis (Rku) of the upper surface 11a of the Al layer 11 is not more than about 7 can be continuously manufactured, and hence the productivity of the metal substrate 1 can be improved.

### EXAMPLE

Next, surface roughness measurement of a metal substrate performed for confirming the effects of the metal substrate according to the aforementioned embodiment, power generation efficiency measurement of a CIGS solar battery and measurement of a distance of diffusion of Fe in a stainless steel layer to an Al layer are now described with reference to FIGS. 1 and 4 to 6.

(Surface Roughness Measurement)

First, the surface roughness measurement is described. In this surface roughness measurement, a cladding material in which an Al layer having an Al content of 99.85% and a stainless steel layer made of SUS430 are bonded to each other was prepared. A thickness of the Al layer is 15% (15 μm) of a thickness (100 μm) of the cladding material, and a thickness of the stainless steel layer is 85% (85 μm) of the thickness of the cladding material. Upper surfaces of Al layers of metal substrates made of the aforementioned cladding material were polished thereby preparing metal substrates of examples 1 to 7 and comparative examples 1 to 4. Further, a metal substrate of a comparative example 5 having an upper surface of an Al layer not polished was prepared from a metal substrate made of the aforementioned cladding material.

More specifically, in the examples 1 to 7, the metal substrates were dipped in a chemical polishing liquid made of a phosphoric acid solution containing 4% of nitric acid maintained at a temperature range of at least about 90° C. and not more than about 110° C. for at least about 60 seconds and not more than about 120 seconds thereby chemically polishing the upper surfaces of the Al layers. A metal substrate 1 of the example 1 was dipped in a chemical polishing liquid maintained at 110° C. for 120 seconds. A metal substrate 1 of the example 2 was dipped in a chemical polishing liquid maintained at 110° C. for 60 seconds. A metal substrate 1 of the example 3 was dipped in a chemical polishing liquid maintained at 100° C. for 120 seconds. A metal substrate 1 of the example 4 was dipped in a chemical polishing liquid maintained at 100° C. for 60 seconds. A metal substrate 1 of the example 5 was dipped in a chemical polishing liquid maintained at 90° C. for 120 seconds.

On the other hand, in the comparative examples 1 and 4, electrolytic compound polishing is performed on the upper surfaces of the Al layers thereby preparing the metal substrates. Electrolytic compound polishing is a method of performing mechanical polishing while dissolving Al of an upper surface of an Al layer with an electropolishing solution by electrolysis. Mechanical polishing is a method of polishing an upper surface of an Al layer by mechanically rubbing a lapping machine and the upper surface of the Al layer together in a state where a polishing agent into which abrasive grains are dispersed intervenes between the lapping machine and the upper surface of the Al layer.

In the comparative examples 2 and 3, only mechanical polishing was performed on the upper surfaces of the Al layers thereby preparing the metal substrates.

Surface roughness on the upper surfaces of the Al layers of the examples 1 to 7 and the comparative examples 1 to 5 was measured with a surface roughness meter (Surfcom 480A, manufactured by Tokyo Seimitsu Co., Ltd.). At this time, surface roughness in a direction (not shown) perpendicular to a rolling direction of the metal substrates was measured. In each of the examples 1 to 7 and the comparative examples 1 to 5, a kurtosis (Rku) and an arithmetic mean height Ra were measured. The kurtosis was calculated from the aforementioned formula (1). The arithmetic mean height Ra was calculated from an average of an absolute value of a height Z(x) in a reference length (Lr) with the following formula (2). When the Ra is small, heights (depths) of irregularities on a surface are small on average. When the Ra is large, on the other hand, heights (depths) of irregularities on a surface are large on average.

$$Ra = \frac{1}{Lr} {\int }_{0}^{Lr} \vert Z ( x ) \vert d x \qquad [ Formula 2 ]$$

In each of the examples 6 and 7 and the comparative examples 3 to 5, a maximum height Rz and ten-point average roughness Rzjis were calculated in addition to a kurtosis and an arithmetic mean height Ra. The maximum height Rz was calculated from a sum of an absolute value of a height of the largest mountain in a reference length and an absolute value of a depth of the largest valley in the reference length. The ten-point average roughness Rzjis was calculated from a sum of an average of absolute values of heights of mountains having the first to fifth largest heights of mountains in the reference length and an average of absolute values of depths of valleys having the first to fifth largest depths of valleys in the reference length in the reference length. As the experimental results of surface roughness measurement shown in FIGS. 4 and 5, the kurtosis (Rku) was not more than 7 in each of the examples 1 to 7 where chemical polishing was performed. More specifically, the Rku was 3.6, and the Ra was 0.035 in the example 1. The Rku was 4.8, and the Ra was 0.024 in the example 2. The Rku was 6.3, and the Ra was 0.021 in the example 3. The Rku was 6.5, and the Ra was 0.006 in the example 4. The Rku was 7.0, and the Ra was 0.007 in the example 5. The Rku was 5.2, and the Ra was 0.032 in the example 6. Further, the Rz was 0.274, and the Rzjis was 0.237 in the example 6. The Rku was 3.5, and the Ra was 0.065 in the example 7. Further, the Rz was 0.464, and the Rzjis was 0.347 in the example 7.

On the other hand, the kurtosis (Rku) was more than 7 in each of the comparative examples 1 and 4 where electrolytic compound polishing was performed, the comparative examples 2 and 3 where mechanical polishing was performed and the comparative example 5 where polishing was not performed. More specifically, the Rku was 7.7, and the Ra was 0.011 in the comparative example 1 where electrolytic compound polishing was performed. The Rku was 8.9, and the Ra was 0.018 in the comparative example 2 where mechanical polishing was performed. The Rku was 16.7, and the Ra was 0.009 in the comparative example 3 where mechanical polishing was performed. Further, the Rz was 0.177, and the Rzjis was 0.153 in the comparative example 3. The Rku was 10.8, and the Ra was 0.005 in the comparative example 4 where electrolytic compound polishing was performed. Further, the Rz was 0.098, and the Rzjis was 0.069 in the comparative example 4. The Rku was 9.0, and the Ra was 0.018 in the comparative example 5 where polishing was not performed. Further, the Rz was 0.302, and the Rzjis was 0.244 in the comparative example 5.

It has been proved from the results of the examples 1 to 7 and the comparative examples 1 to 5 shown in FIGS. 4 and 5 that the kurtoses on the upper surfaces of the Al layers can be controlled to not more than 7 by performing chemical polishing on the upper surfaces of the Al layers. This is conceivably because an end of a sharply pointed projecting portion (the extraneous substance 400 in FIG. 3 or the like) on the upper surface of the Al layer, a peripheral portion of a sharply pointed recess portion and the like were sufficiently dissolved when dipping the metal substrate in a chemical polishing liquid, whereby a corrugated shape smoothed.

Correlations could not be found between the kurtosis and the Ra, and the Rz and the Rzjis from the results of the examples 6 and 7 and the comparative examples 3 to 5 shown in FIG. 5.

(Power Generation Efficiency Measurement)

A plurality of unit solar cells were prepared on the upper surfaces of the Al layers of the polished metal substrates of the examples 1 to 5 and the polished metal substrates of the comparative examples 1 and 2 employed in the aforementioned surface roughness measurement through a manufacturing method similar to the method of manufacturing the CIGS solar cell 100 in the aforementioned embodiment, thereby preparing CIGS solar batteries corresponding to the respective examples 1 to 5 and comparative examples 1 and 2.

Then, energies generated in the CIGS solar batteries in applying light of a prescribed energy to the CIGS solar batteries of the examples 1 to 5 and the comparative examples 1 and 2 were measured to calculate power generation efficiency. At this time, it has been determined that the CIGS solar batteries have sufficient power generation efficiency (circle in FIG. 4) when the power generation efficiency is at least 10%. On the other hand, it has been determined that the CIGS solar batteries do not have sufficient power generation efficiency (triangle in FIG. 4) when the power generation efficiency is less than 10%. It has been determined that the CIGS solar batteries do not generate power (cross in FIG. 4) when a power generation state is indeterminable.

As the experimental results of power generation efficiency measurement shown in FIG. 4, power generation efficiency of the CIGS solar batteries was at least 10% in the examples 1 to 5 where the kurtoses are not more than 7. More specifically, it has been confirmed that the power generation efficiency of the CIGS solar battery was at least 10% in any of the example 1 (Rku=3.6), the example 2 (Rku=4.8), the example 3 (Rku=6.3), the example 4 (Rku=6.5) and the example 5 (Rku=7.0) where chemical polishing was performed.

On the other hand, power generation efficiency of the CIGS solar batteries was less than 10% in the comparative examples 1 and 2 where the kurtoses are more than 7. More specifically, the power generation efficiency of the CIGS solar battery was less than 10% in the comparative example 1 (Rku=7.7) where electrolytic compound polishing was performed. Power generation in the CIGS solar battery could not be confirmed in the comparative example 2 (Rku=8.9) where mechanical polishing was performed.

It has been proved from the results of the examples 1 to 5 and the comparative examples 1 and 2 that the power generation efficiency is at least 10% when the kurtosis is not more than 7 whereas the power generation efficiency is less than 10% when the kurtosis is more than 7. This is conceivably because a whole area including not only an upper surface without an extraneous substance or a valley portion (groove portion) but also a surface of the extraneous substance, an interface between the extraneous substance and the upper surface and an upper surface of a portion formed with the valley portion was smooth also in a case where the extraneous substance and/or the valley portion existed on the upper surface of the metal substrate, when the kurtosis was not more than 7, and hence the unit solar cells were formed to have a substantially uniform layered structure, and the power generation efficiency of the unit solar cells was inhibited from decrease. On the other hand, this is conceivably because defects were caused in the unit solar cells formed on the upper surface of the metal substrate due to the presence of an extraneous substance sharply pointed, a groove portion recessed in a wedge shape and the like on the upper surface of the metal substrate, when the kurtosis was more than 7, and hence the power generation efficiency of the unit solar cells was decreased.

Further, a correlation in which the power generation efficiency is at least 10% when the kurtosis is not more than 7 and the power generation efficiency is less than 10% when the kurtosis is more than 7 could be confirmed between the kurtosis and the power generation efficiency from the results of the examples 1 to 5 and the comparative examples 1 and 2. On the other hand, a correlation between the arithmetic mean height Ra and the power generation efficiency could not be confirmed. Even when heights (depths) of irregularities of an upper surface of a metal layer are small on average (an Ra is small), defects are easily caused in unit solar cells formed on the upper surface of the metal substrate in a state where the irregularities of the upper surface of the metal substrate are sharply pointed (an Rku is large). Thus, an arithmetic mean height Ra conceivably has a small influence on power generation efficiency as compared with a kurtosis, and hence a correlation between the Ra and the power generation efficiency was not conceivably obtained.

(Fe Diffusion Distance Measurement)

Next, Fe diffusion distance measurement is described. In this Fe diffusion distance measurement, the metal substrate 1 constituted by the Al layer 11 and the stainless steel layer 12 in the aforementioned embodiment was thermally treated by maintaining the same under a nitrogen atmosphere under a temperature condition of 400° C. for 10 hours. An image showing a distribution of elements (Fe and Al) was prepared by an electron probe micro analyzer (EPMA). A distance of diffusion of Fe in the stainless steel layer 12 into the Al layer 11 was obtained from the prepared image.

As the experimental result of Fe diffusion distance measurement, a region (diffusion region 112) of the Al layer 11 to which Fe in the stainless steel layer 12 is diffusing could be confirmed in the metal substrate 1, as shown in FIG. 6. Further, the diffusion region 112 was formed with a height of 1.4 μm (distance L1) in the direction Z1 from the lower surface 11b of the Al layer 11. It has been proved from this result that Fe in the stainless steel layer 12 can be conceivably inhibited from reaching the upper surface 11a (see FIG. 1) of the Al layer 11 by forming the Al layer 11 with the thickness t3 (see FIG. 1) of at least 1.5 μm.

The embodiment and Examples disclosed this time must be considered as illustrative in all points and not restrictive. The range of the present invention is shown not by the above description of the embodiment and Examples but by the scope of claims for patent, and all modifications within the meaning and range equivalent to the scope of claims for patent are included.

While the example of making the metal substrate 1 of the cladding material in which the Al layer 11 and the stainless steel layer 12 are bonded to each other has been shown in the aforementioned embodiment, the present invention is not restricted to this. In the present invention, the metal substrate may further comprise another metal layer on a surface of the stainless steel layer opposite to the Al layer or comprise another metal layer between the Al layer and the stainless steel layer.

While the example of making the light absorption layer 22 of a semiconductor having a composition of Cu(In₁₋ₓGaₓ)Se₂ (CIGS) has been shown in the aforementioned embodiment, the present invention is not restricted to this. For example, the light absorption layer may be made of a semiconductor having a composition of Si, CuInSe₂ (CIS), Cu₂ZnSnS₄ (CZTS) or CdTe.

While the example of setting the thickness t3 of the Al layer 11 (first metal layer) to about 15 μm has been shown in the aforementioned embodiment, the present invention is not restricted to this. In the present invention, the thickness of the first metal layer may be more than about 15 μm or less than about 15 μm. At this time, it is preferred to set the thickness of the first metal layer to at least about 1.5 μm from the viewpoint that Fe in the second metal layer can be inhibited from reaching the first surface of the first metal layer.

While the example of setting the thickness t4 of the stainless steel layer 12 (second metal layer) to about 85 μm has been shown in the aforementioned embodiment, the present invention is not restricted to this. In the present invention, the thickness of the second metal layer may be more than about 85 μm or less than about 85 μm. At this time, it is preferred to set the thickness of the second metal layer to at least about 60 μm (about 60% of the thickness (about 100 μm) of the metal substrate) from the viewpoint that the rigidity of the metal substrate can be reliably increased.

While the example of setting the difference between the thermal expansion coefficient (about 11×10⁻⁶/°C.) of the stainless steel layer 12 (second metal layer) and the thermal expansion coefficient (about 10×10⁻⁶/°C.) of the unit solar cells 2 to about 1×10⁻⁶/°C. by employing the stainless steel layer 12 as the second metal layer has been shown in the aforementioned embodiment, the present invention is not restricted to this. In the present invention, the difference between the thermal expansion coefficient of the second metal layer and the thermal expansion coefficient of the unit solar cells may be larger or smaller than about 1×10⁻⁶/°C. At this time, it is preferred to set the thermal expansion coefficient of the second metal layer to at least about 5×10⁻⁶/°C. and not more than about 15×10⁻⁶/°C. from the viewpoint that the entire metal substrate for a solar battery can be inhibited from deformation.

While the example of forming the Al layer 11 (first metal layer) to have an Al content of at least about 99.7% has been shown in the aforementioned embodiment, the present invention is not restricted to this. For example, the first metal layer may be made of an Al alloy superior in ductility, containing less than about 99.7% of Al. Alternatively, the first metal layer may be made of Cu or a Cu alloy superior in ductility.

While the example of making the stainless steel layer 12 (second metal layer) of SUS430 (ferritic stainless steel) has been shown in the aforementioned embodiment, the present invention is not restricted to this. For example, the second metal layer may be made of pure iron (Fe) more inexpensive than SUS430.

While the example of performing chemical polishing with the chemical polishing liquid mainly containing phosphoric acid and containing about 4% of nitric acid has been shown in the aforementioned embodiment, the present invention is not restricted to this. In the present invention, the chemical polishing liquid may be made of an aqueous solution containing at least about 3% and not more than about 9% of nitric acid and at least about 66% and not more than about 90% of phosphoric acid.

While the example of performing no polishing such as mechanical polishing on the upper surface 11a of the metal substrate 1 before chemical polishing has been shown in the aforementioned embodiment, the present invention is not restricted to this. In the present invention, polishing such as mechanical polishing may be performed on the upper surface of the metal substrate as a preliminary step for chemical polishing.

While the example of continuously forming the cladding material having a kurtosis of not more than about 7 on the upper surface 11a of the Al layer 11 by chemically polishing the continuously formed cladding material has been shown in the aforementioned embodiment, the present invention is not restricted to this. In the present invention, no cladding material having a kurtosis of not more than about 7 may be continuously formed. For example, chemical polishing may be performed on cut cladding materials after the continuously formed cladding material is previously cut into a prescribed size.

1. A metal substrate (1) for a solar battery, comprising a cladding material including a first metal layer (11) having a first surface (11a) formed with a unit solar cell (2) and a second metal layer (12) bonded to said first metal layer on a second surface (11b) opposite to said first surface, wherein
a kurtosis (Rku) serving as an index indicating surface roughness of said first surface is not more than 7.

2. The metal substrate for a solar battery according to claim 1, wherein
said kurtosis (Rku) of said first surface of said first metal layer is smaller than that of a surface of said second metal layer, and
said second metal layer has higher rigidity than said first metal layer.

3. The metal substrate for a solar battery according to claim 1, wherein
a difference between a thermal expansion coefficient of said second metal layer and a thermal expansion coefficient of said unit solar cell is smaller than a difference between a thermal expansion coefficient of said first metal layer and said thermal expansion coefficient of said unit solar cell.

4. The metal substrate for a solar battery according to claim 3, wherein
said difference between said thermal expansion coefficient of said second metal layer and said thermal expansion coefficient of said unit solar cell is not more than 5×10⁻⁶/°C.

5. The metal substrate for a solar battery according to claim 1, wherein
said first metal layer has greater ductility than said second metal layer.

6. The metal substrate for a solar battery according to claim 1, wherein
said first metal layer is made of any one of Al, Cu, an Al alloy and a Cu alloy, and
said second metal layer is made of Fe or ferritic stainless steel.

7. The metal substrate for a solar battery according to claim 6, wherein
a thickness of said second metal layer is at least 60% of a total thickness including at least a thickness of said first metal layer and a thickness of said second metal layer.

8. The metal substrate for a solar battery according to claim 6, wherein
a thickness of said first metal layer is at least 1.5 μm.

9. The metal substrate for a solar battery according to claim 6, wherein
said first metal layer has an Al content of at least 99.7 mass %.

10. The metal substrate for a solar battery according to claim 6, wherein
said second metal layer is made of ferritic stainless steel.

11. The metal substrate for a solar battery according to claim 1, wherein
a semiconductor layer of said unit solar cell, made of any one of Si, CuInSe₂, CuIn₁₋ₓGaₓSe₂, Cu₂ZnSnS₄ and CdTe is grown on said first surface of said first metal layer.

12. The metal substrate for a solar battery according to claim 1, wherein
at least one of an extraneous substance (200), a valley portion (300a) and a mountain portion (300b) exists on said first surface of said first metal layer, and
said kurtosis (Rku) of said first surface on which at least one of said extraneous substance, said valley portion and said mountain portion exists is not more than 7.

13. A method of manufacturing a metal substrate for a solar battery comprising steps of:
forming a metal substrate for a solar battery comprising a cladding material including a first metal layer having a first surface formed with a unit solar cell and a second metal layer bonded to said first metal layer on a second surface opposite to said first surface by bonding a first metal plate and a second metal plate to each other, and
setting a kurtosis (Rku) serving as an index indicating surface roughness of said first surface to not more than 7 by polishing said first surface of said first metal layer.

14. The method of manufacturing a metal substrate for a solar battery according to claim 13, wherein
said step of setting said kurtosis (Rku) of said first surface of said first metal layer to not more than 7 includes a step of polishing said first surface of said first metal layer by chemical polishing.

15. The method of manufacturing a metal substrate for a solar battery according to claim 14, wherein
said step of forming said metal substrate for a solar battery includes a step of forming said metal substrate for a solar battery comprising said cladding material including said first metal layer made of any one of Al, Cu, an Al alloy and a Cu alloy and said second metal layer by bonding said first metal plate made of any one of Al, Cu, an Al alloy and a Cu alloy and said second metal plate to each other, and
said step of polishing said first surface of said first metal layer by said chemical polishing has a step of polishing said first surface of said first metal layer by dipping said metal substrate for a solar battery in a chemical polishing liquid containing phosphoric acid.

16. The method of manufacturing a metal substrate for a solar battery according to claim 13, wherein
said step of forming said metal substrate for a solar battery includes a step of forming said metal substrate for a solar battery comprising said cladding material including said first metal layer made of any one of Al, Cu, an Al alloy and a Cu alloy and said second metal layer made of Fe or ferritic stainless steel by bonding said first metal plate made of any one of Al, Cu, an Al alloy and a Cu alloy and said second metal plate made of Fe or ferritic stainless steel to each other.

17. The method of manufacturing a metal substrate for a solar battery according to claim 16, wherein
said step of forming said metal substrate for a solar battery includes a step of forming said metal substrate for a solar battery so that a thickness of said second metal layer is at least 60% of a total thickness including at least a thickness of said first metal layer and a thickness of said second metal layer.

18. The method of manufacturing a metal substrate for a solar battery according to claim 16, wherein
said step of forming said metal substrate for a solar battery includes a step of forming said metal substrate for a solar battery so that a thickness of said first metal layer is at least 1.5 μm.

19. The method of manufacturing a metal substrate for a solar battery according to claim 13, wherein
said step of forming said metal substrate for a solar battery includes a step of cold-rolling said cladding material after forming said cladding material by bonding said first metal plate having greater ductility than said second metal plate and said second metal plate to each other.

20. The method of manufacturing a metal substrate for a solar battery according to claim 14, wherein
said step of forming said metal substrate for a solar battery includes a step of continuously forming said cladding material by bonding rolled said first metal plate and rolled said second metal plate to each other, and
said step of setting said kurtosis (Rku) of said first surface of said first metal layer to not more than 7 includes a step of chemically polishing said first surface of said first metal layer of continuously formed said cladding material.
